(19) United States
(12) Patent Application Publication
(10) Pub. No.: US 2010/0319513 A1
(43) Pub. Date: Dec. 23, 2010

(54) COMBINED SPLITTING BLADE

(76) Inventor: Yu-Chang Hsu, Yangmei Town (TW)

Correspondence Address: EGBERT LAW OFFICES, 412 MAIN STREET, 7TH FLOOR, HOUSTON, TX, 77002, US

(21) Appl. No.: 12/488,572

(22) Filed: Jun. 21, 2009

(51) Int. Cl. B26D 1/00

(52) U.S. Cl. 83/651; 30/316

(57) ABSTRACT

The present invention provides a combined splitting blade, including a cutting ring and a fixed disc. The cutting ring is provided with a through-hole for the flange and a blade formed on the periphery. The fixed disc is partially covered on the upper and lower end surfaces around the through-hole of the cutting ring by die-casting. The cutting ring is clamped tightly. The fixed disc and the cutting ring are made of different materials. As the cutting ring and fixed disc are not prefabricated nor made of the same kind of materials, thus simplifying the fabrication process of the blade to save the cost of materials, processing and fabrication time. In addition, the combined splitting blade is fabricated by of rolling.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a splitting blade, and more particularly to a combined one.

2. Description of Related Art Including Information Disclosed Under 37 CFR 1.97 and 37 CFR 1.98.

The blade of a typical pneumatic splitting tool is generally prefabricated; namely, the entire blade body is processed by the same kind of material. Generally, the blade is structurally designed into a disc that is characterized as having a clamping portion and a cutting portion formed externally onto the clamping portion. The clamping portion is thicker than the cutting portion, such that the blade can be firmly clamped by the machine.

The blade must be fabricated in such a way that the entire steel block is milled to remove excessive steel material. The surface of clamping portion is grinded to ensure the flatness of the clamping portion; however, the steel material removed during milling process is almost tantamount to the volume of the blade itself.

Moreover, the cutting edge formed externally onto the cutting portion must be milled and then processed, leading to a higher cost of materials and processing. Furthermore, the prefabricated blade will cause poorer heat-radiation after long-lasting operation.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

One objective of the present invention is to provide a combined splitting blade that neither of the cutting ring and fixed disc are prefabricated and made of the same material, thus simplifying the fabrication process of blade to save the cost of materials, processing and fabrication time.

For the objective mentioned above, the present invention provides a combined splitting blade, which contains a cutting ring and a fixed disc. The cutting ring is provided with a through-hole and a blade on the outer edge. The fixed disc is partially covered on the upper and lower end surfaces around the through-hole of the cutting ring by means of die-casting, and the cutting ring is clamped tightly. Moreover, the fixed disc and the cutting ring are made of different materials.

For the objective mentioned above, the present invention provides a combined splitting blade, which contains a fixed disc, a ring wall and a cutting ring. A flange is extended from one end surface of the fixed disc, and the ring wall is extended from the periphery of the flange. The cutting ring is provided with a through-hole for the flange and a blade formed on the periphery. The cutting ring and fixed disc are made of different materials. The ring wall is folded, and the cutting ring is clamped tightly on the fixed disc.

The efficacy of the present invention lies in that it can resolve the shortcomings of the prior art, such as higher costs of materials and processing. The fixed disc and the cutting ring of the combined splitting blade are made of different materials. The fixed disc is made of low-cost materials featuring strength. In addition to simpler manufacturing process, the present invention can save the cost of materials, processing and fabrication time. It can also resolve the shortcomings of prior art including poorer heat-radiation after long-lasting operation of the prefabricated splitting blade. The cutting ring of the present invention can be made of metallic materials featuring strength and better heat-radiation.

### BRIEF DESCRIPTION OF THE SEVERAL VIEWS OF THE DRAWINGS

FIG. 1 shows a sectional view of the fabrication process of the present invention (1).

FIG. 2 shows a sectional view of the fabrication process of the present invention (2).

FIG. 3 shows an exploded perspective view of the present invention.

FIG. 4 shows an external perspective view of the present invention.

FIG. 5 shows a sectional view of another preferred embodiment of the present invention.

### DETAILED DESCRIPTION OF THE INVENTION

The details and technical contents of the present invention will be more readily understood with reference to the accompanying drawings without limitation of the present invention.

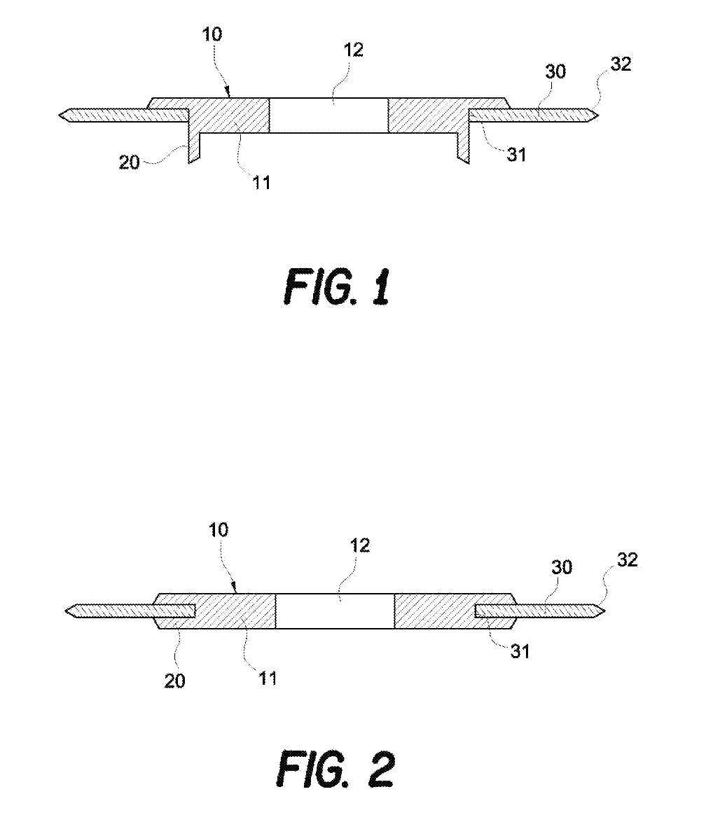

Referring to FIGS. 1 and 2 showing sectional views (1) (2) of the fabrication process of the present invention, the present invention provides a combined splitting blade, which comprises a fixed disc 10, a ring wall 20 and a cutting ring 30.

A flange is extended from one end surface of the fixed disc 10. The fixed disc 10 is fitted with a through-hole 12 for insertion and positioning of the machine table. The fixed disc 10 may be made of low-cost materials featuring strong strength, such as plastic steel.

The ring wall 20 is extended from the periphery of the flange 11. Moreover, the ring wall 20 and fixed disc 10 run perpendicularly, while the inner surface of ring wall 20 is under an inclination state.

The cutting ring 30 is provided with a through-hole 31 for the flange 11 and a blade 32 formed on the periphery. The cutting ring 30 and fixed disc 10 are made of different materials, e.g. the cutting ring 30 can be made of SKD-11 die steel. Furthermore, owing to the thin profile and uniform thickness of the cutting ring 30, the cutting ring 30 can be punched, and then the blade 32 is molded. Next, the cutting ring 30 is grinded in lieu of milling process, thus saving the cost of time, materials and processing.

The ring wall 20 is folded, and the cutting ring 30 is clamped tightly onto the fixed disc 10. Furthermore, when this combined splitting blade 1 is processed, the cutting ring 30 is sleeved onto the flange 11 of the fixed disc 10. Then, the ring wall 20 is folded 90° downwards by a roll mill, so that the cutting ring 30 is clamped tightly onto the fixed disc 10. The external surfaces of the fixed disc 10 and folded ring wall 20 are of oblique shape, where the clamping force of the fixed disc 10 for the cutting ring 30 can be concentrated.

Before the ring wall 20 is folded, the oblique end surface is turned towards the center of the fixed disc 10. In such a case, the ring wall 20 could be folded towards the exterior of the fixed disc 10 by the roll mill.

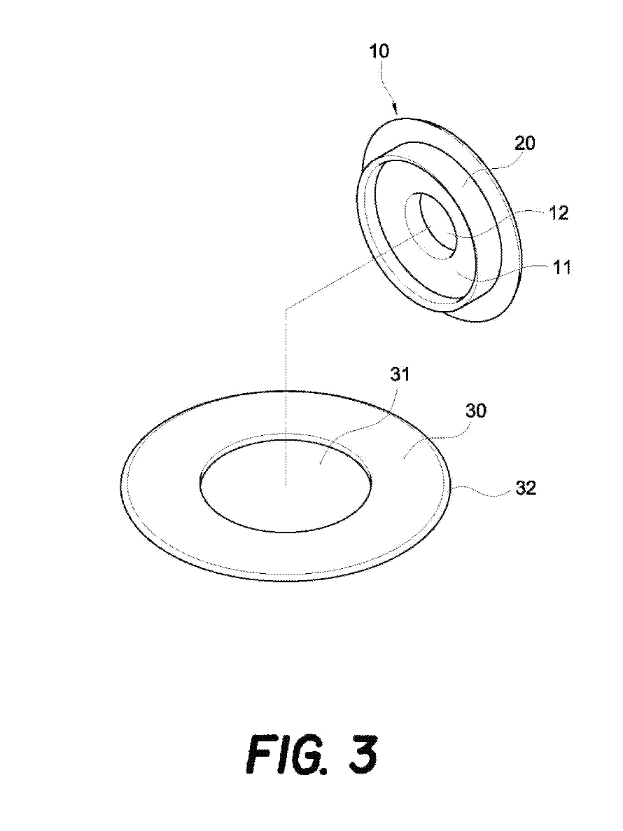

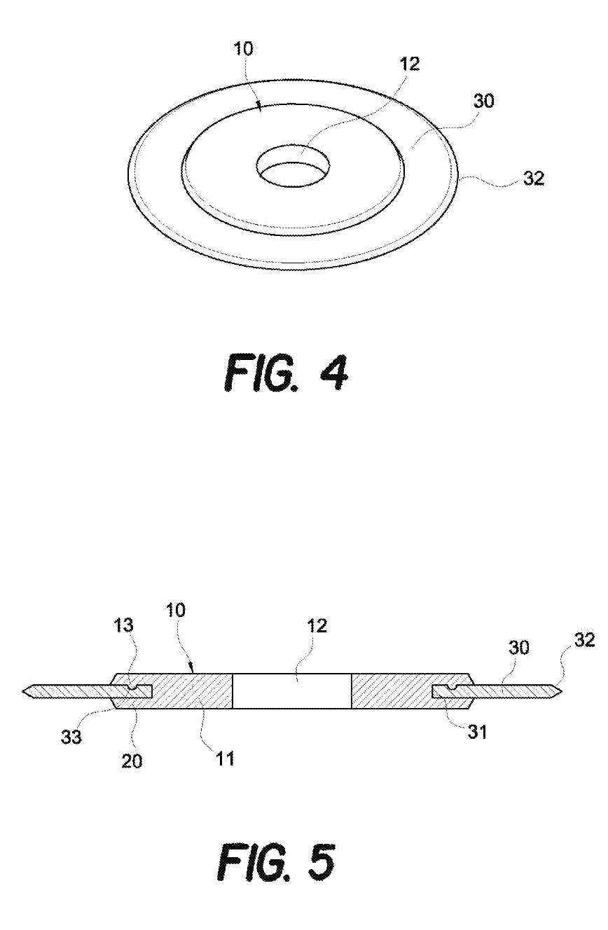

Referring to FIGS. 3 and 4, being an exploded perspective view and an outside perspective view of the present invention, respectively, when the combined splitting blade 1 is fabricated, the fixed disc 10 and the cutting ring 30 are assembled by means of rolling, casting or injection molding. Furthermore, the fixed disc 10 can be fabricated by means of die-casting, so when the combined splitting blade is fabricated by means of rolling, the blade 1 contains a cutting ring 30 and a fixed disc 10.

The cutting ring 30 is provided with a through-hole 31 and a blade 32 formed on the outer edge. The fixed disc 10 is partially covered on the upper and lower end surfaces around the through-hole 31 of the cutting ring 30 by means of die-casting, and the cutting ring is clamped tightly.

Referring to FIG. 5, a sectional view of another preferred embodiment of the present invention, the fixed disc 10 of the preferred embodiment is fitted with a plurality of locating bulges 13, and the cutting ring 30 is fitted with a plurality of locating slots 33 interlocked with the locating bulges 13. When the combined splitting blade 1 is used for high-speed cutting, the cutting ring 30 and the fixed disc 10 can be fixed as the locating slots 33 are interlocked with the locating bulges 13, so the cutting ring 30 will not slide in relation to the fixed disc 10.

Although the invention has been explained in relation to its preferred embodiment, it is to be understood that many other possible modifications and variations can be made without departing from the spirit and scope of the invention as hereinafter claimed.

1. A combined splitting blade, comprising:
a cutting ring, being provided with a through-hole and a blade formed on a periphery of said cutting ring; and
a fixed disc, being partially covered on upper and lower end surfaces around the through-hole of the cutting ring by die-casting, said cutting ring is clamped tightly, said fixed disc and said cutting ring being made of different materials.

2. The splitting blade defined in claim 1, wherein the cutting ring is fitted with a locating slot, said fixed disc being fitted with a locating bulge interlocked with said locating slot.

3. The splitting blade defined in claim 1, wherein the external surface of the fixed disc is of an oblique shape.

4. The splitting blade defined in claim 1, wherein the cutting ring is fabricated by punching.

5. The splitting blade defined in claim 1, wherein the cutting ring is comprised of SKD-11 die steel.

6. The splitting blade defined in claim 1, wherein the fixed disc is comprised of plastic steel.

7. A combined splitting blade, comprising:
a fixed disc, having one end with a flange is extended therefrom;
a ring wall, extended from the periphery of the flange; and
a cutting ring, being provided with a through-hole for the flange and a blade formed on the periphery, said cutting ring and the fixed disc being comprised of different materials, wherein said ring wall is folded and the cutting ring is clamped tightly on the fixed disc.

8. The splitting blade defined in claim 7, wherein the ring wall is folded by of rolling.

9. The splitting blade defined in claim 7, wherein the fixed disc is fitted with a locating bulge, said cutting ring being fitted with a locating slot interlocked with the locating bulge.

10. The splitting blade defined in claim 7, wherein external surfaces of the fixed disc and ring wall are of oblique shape.

11. The splitting blade defined in claim 7, wherein said cutting ring is fabricated by punching.

12. The splitting blade defined in claim 7, wherein the cutting ring is comprised of SKD-11 die steel.

13. The splitting blade defined in claim 7, wherein the fixed disc is comprised of plastic steel.
